(19) United States
(12) Patent Application Publication
(10) Pub. No.: US 2024/0211355 A1
(43) Pub. Date: Jun. 27, 2024

(54) SYSTEM AND METHOD FOR DATA SERVER CHANGE MANAGEMENT

(71) Applicant: ABELHealth Inc., Burlington (CA)

(72) Inventors: Arun RELE, Burlington (CA); Lukas MILLS, Burlington (CA)

(21) Appl. No.: 18/530,915

(22) Filed: Dec. 6, 2023

Related U.S. Application Data
(60) Provisional application No. 63/434,840, filed on Dec. 22, 2022.

(51) Int. Cl. G06F 11/14

(52) U.S. Cl. CPC G06F 11/1469; G06F 11/1464

(57) ABSTRACT

Systems, computing platforms, methods, and storage media for data server change management with respect to a software application are disclosed. Exemplary implementations may: obtain, on application start-up, an application configuration file including data server information, for example a data server address, associated with a data server on which an application database is stored; determine that a data server change has occurred based on a comparison of the data server information in the application configuration file with prior data server information associated with a prior client instance of the software application; and provide a data server change notification to a user associated with the software application based on determining that the data server change has occurred, to avoid application database backup from an out-of-date data server.

### CROSS-REFERENCE TO RELATED APPLICATIONS

This application claims benefit of U.S. provisional patent application Ser. No. 63/434,840 filed Dec. 22, 2022, the contents of which are incorporated entirely herein by reference.

### FIELD

The present disclosure relates to software applications and application databases, including but not limited to systems, computing platforms, methods, and storage media for data server change management with respect to a software application.

### BACKGROUND

A software application may store its application database in a data server. The application database may include different sets of data associated with launching and running a client instance of the software application. An administrator or office technician may be responsible for management of the software application.

A change may occur with respect to the data server on which the application database is stored. For example, an application database may be moved from one data server to another based on technical issues or reasons unbeknownst to the administrator of the software application. This may be done such that the change is transparent to a user of the software application. When a data server change happens, it is quite possible for the administrator or office technician to not be aware of such a data server change. In the case of a data server change, a third-party remote backup system may need to be reconfigured to properly back up information from the proper data server, for the office's protection.

Improvements in approaches for data server change management with respect to a software application are desirable.

### SUMMARY

One aspect of the present disclosure relates to a system or computing platform configured for data server change management with respect to a software application. The computing platform may include a non-transient computer-readable storage medium having executable instructions embodied thereon. The computing platform may include one or more hardware processors configured to execute the instructions. The processor(s) may execute the instructions to obtain, on application start-up, an application configuration file including data server information associated with a data server on which an application database is stored. The application database may be associated with a current client instance of the software application. The processor(s) may execute the instructions to determine that a data server change has occurred based on a comparison of the data server information in the application configuration file with prior data server information associated with a prior client instance of the software application. The processor(s) may execute the instructions to provide a data server change notification to a user associated with the software application based on determining that the data server change has occurred, to avoid application database backup from an out-of-date data server.

Another aspect of the present disclosure relates to a method for data server change management with respect to a software application. The method may include obtaining, on application start-up, an application configuration file including data server information associated with a data server on which an application database is stored. The application database may be associated with a current client instance of the software application. The method may include determining that a data server change has occurred based on a comparison of the data server information in the application configuration file with prior data server information associated with a prior client instance of the software application. The method may include providing a data server change notification to a user associated with the software application based on determining that the data server change has occurred, to avoid application database backup from an out-of-date data server.

Yet another aspect of the present disclosure relates to a non-transient computer-readable storage medium having instructions embodied thereon, the instructions being executable by one or more processors to perform a method for data server change management with respect to a software application. The method may include obtaining, on application start-up, an application configuration file including data server information associated with a data server on which an application database is stored. The application database may be associated with a current client instance of the software application. The method may include determining that a data server change has occurred based on a comparison of the data server information in the application configuration file with prior data server information associated with a prior client instance of the software application. The method may include providing a data server change notification to a user associated with the software application based on determining that the data server change has occurred, to avoid application database backup from an out-of-date data server.

### BRIEF DESCRIPTION OF THE DRAWINGS

Embodiments of the present disclosure will now be described, by way of example only, with reference to the attached Figures.

FIG. 1 illustrates a system configured for data server change management with respect to a software application, in accordance with one or more embodiments.

FIG. 2 illustrates another system configured for data server change management with respect to a software application, in accordance with one or more embodiments.

FIG. 3 illustrates a method for data server change management with respect to a software application, in accordance with one or more embodiments.

FIG. 4 illustrates another method for data server change management with respect to a software application, in accordance with one or more embodiments.

### DETAILED DESCRIPTION

Systems, computing platforms, methods, and storage media for data server change management with respect to a software application are disclosed. Exemplary implementations may: obtain, on application start-up, an application configuration file including data server information associated with a data server on which an application database is stored; determine that a data server change has occurred based on a comparison of the data server information in the application configuration file with prior data server information associated with a prior client instance of the software application; and provide a data server change notification to a user associated with the software application based on determining that the data server change has occurred, to avoid application database backup from an out-of-date data server.

The present disclosure provides an approach for managing data server changes, for example with respect to a software application that stores its application database in a data server. Embodiments of the present disclosure may automatically determine when a new data server is being used, by detecting a change in a data server link on application start-up, and notify a user to update remote back-up settings accordingly.

Without updating the back-up settings, an office running a software application may keep backing up an old application database from the wrong data server. This can lead to disastrous consequences when an up-to-date backup is needed. There is currently no known method of efficiently dealing with such a problem, beyond proactively training clients to be aware of the need to reconfigure their back-ups if a data server is changed or replaced, and encouraging them to manually check on a regular basis.

Customers often automate database back-ups, for example utilizing third party products, and depend on third party technicians to back-up the application database from the data server. When there is a data server change, according to known approaches the customer must recognize the data server change and manually notify their backup service of the data server change, so that the backup service makes the corresponding change. A drawback with known approaches is that if there is server change, available solutions do not automatically determine the correct data server to be backed up. Consequently, if the data server is changed, a backup solution, without manual intervention, can keep backing up an old application database from the wrong server.

According to one or more embodiments, the present disclosure manages data server changes, for example with respect to a software application that stores its application database in a data server. Embodiments of the present disclosure may automatically determine, in association with the software application itself, when a new data server is being used, by detecting a change in a data server link on application start-up, and notify a user to update remote back-up settings. Embodiments of the present disclosure are agnostic with respect to the backup solution, and deal with changes to the location of source data, rather than changes to the address of a backup server. This is in contrast to some known approaches in which a backup system may keep track of and advise on changes to a backup server, but has no capabilities associated with changes to a data server storing the application database. According to one or more embodiments, a change in a data server on which a current version of an application database is managed within, or in association with, the software application itself, and a notification may be provided so that a current data server location may be updated in association with a backup arrangement.

For the purpose of promoting an understanding of the principles of the disclosure, reference will now be made to the features illustrated in the drawings and specific language will be used to describe the same. It will nevertheless be understood that no limitation of the scope of the disclosure is thereby intended. Any alterations and further modifications, and any further applications of the principles of the disclosure as described herein are contemplated as would normally occur to one skilled in the art to which the disclosure relates. It will be apparent to those skilled in the relevant art that some features that are not relevant to the present disclosure may not be shown in the drawings for the sake of clarity.

Certain terms used in this application and their meaning as used in this context are set forth in the description below. To the extent a term used herein is not defined, it should be given the broadest definition persons in the pertinent art have given that term as reflected in at least one printed publication or issued patent. Further, the present processes are not limited by the usage of the terms shown below, as all equivalents, synonyms, new developments and terms or processes that serve the same or a similar purpose are considered to be within the scope of the present disclosure.

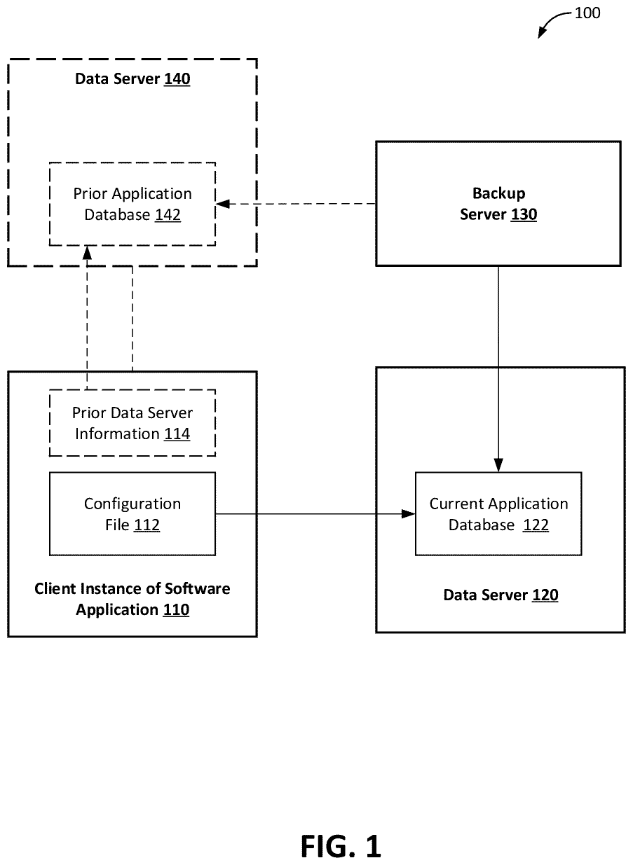

FIG. 1 illustrates a system 100 configured for data server change management with respect to a software application, in accordance with one or more embodiments. The system 100 comprises a client instance of a software application 110, a data server 120 storing a current application database 122, and a backup server 130. The backup server 130 may be configured to regularly backup the application database. The software application 110 may comprise any type of software application, including but not limited to practice management software, such as clinical or dental practice management software. The client instance of the software application 110 comprises or has access to a configuration file 112 pointing to the current application database 122, and comprises or has access to prior data server information 114, for example including a pointer to a prior application database 142 on a different data server 140.

The system 100 may comprise a non-transient computer-readable storage medium having executable instructions embodied thereon, and one or more hardware processors configured to execute the instructions to perform a method of data server change management with respect to a software application, in accordance with one or more embodiments.

In an embodiment, the client instance of the software application 110 is configured to obtain, on application start-up, an application configuration file 112 including data server information associated with a data server 120 on which an application database 122, for example a current application database, is stored. The application database 122 is associated with a current client instance of the software application. Application start-up may refer to launching or starting the software application when the software application was previously closed, for example at the end of a business day. The data server may comprise one or more computer-readable media, or computer-readable memories, on which data may be stored, and may include one or more physical or virtual memories, devices or machines. The current client instance of the software application refers to a current instance of the software application, as opposed to a prior instance, and for example as defined with respect to data in current versions of the configuration file and the application database.

The application configuration file 112 may comprise configuration data used to configure the current client instance of the software application, for example including setup preferences, language preferences, and providing a reference to the application database on which data associated with a client instance of the software application is stored. In the example embodiment in which the software application 110 comprises practice management software, such as clinical or dental practice management software, the application database may comprise patient data for a plurality of patients. In other implementations, the application database may comprise customer data for a plurality of customers.

The client instance of the software application 110 may be configured to determine that a data server change has occurred based on a comparison of the data server information in the application configuration file 112 with prior data server information 114 associated with a prior client instance of the software application. The client instance of the software application 110 may be configured to not only determine but also to detect a change in a location of the data server on which the application database is stored. The data server change may comprise any change with respect to the data server, such as a change in a location, name or resource identifier associated with the data server. Detection and notification of a change with respect to the data server is important in order to ensure that any backup arrangements are configured to properly backup the current version of the application database from the proper and current data server.

The client instance of the software application 110 may be configured to provide a data server change notification to a user associated with the software application based on determining that the data server change has occurred, to avoid application database backup from an out-of-date data server.

In an example embodiment, the data server information may comprise a data server address, and the client instance of the software application may be configured to determine that the data server address has changed in response to detecting a difference between the data server address in the application configuration file 112 and a prior data server address in the prior data server information 114.

The client instance of the software application 110 may be configured to provide a reset recommendation notification to the user to reset a data server link with respect to a backup service, which may include the backup server 130. The data server link may be provided in the configuration file. The reset recommendation notification may be provided in association with the software application and independent of the backup service. The reset recommendation notification may be any suitable notification, for example a pop-up notification associated with the software application, an email message, a text message, or any other form of communication associated with and authorized with respect to the software application. For example, the software application may generate and display a pop-up notification to a user currently starting up the software application on the same device on which the software application is being run, and may also generate and send a message such as an email message or text message to an administrator of the client instance of the software application.

The reset recommendation notification may comprise a general message that a data server change has occurred, along with a recommendation to update data server settings in any backup arrangement. The reset recommendation notification may also comprise updated data server information relating to the updated data server, and may optionally comprise the prior data server information, to enable a user to more easily update the backup settings, or instruct updating of the backup settings. In an example embodiment, the software application may generate a backup server update notification, comprising updated data server information and the prior data server information in a format such that a backup system may ingest the backup server update notification and automatically update the backup data to reflect the data server change.

As described in relation to FIG. 1, an embodiment of the present disclosure may automatically detect a change in a data server location, for example when a prior data server 140 is replaced with a new data server 120, to ensure proper backup of the data server storing the current application database 122.

When launching a client instance of a software application 110, the software may automatically obtain a data server link, and determine that a change in data server has occurred in response to detecting a change in a link or identifier in the configuration file 112 that the software application 110 uses to read the application database 122. The software application 110 may be configured to notify a user to ensure that the data server change is reflected in their backup process. The software application 110 may be configured to optionally automatically notify the user's backup service, to ensure that the data server change is reflected in their backup process. In an example embodiment, the notification to the user's backup service may comprise the updated data server information and optionally the prior data server information, to enable the backup service to automatically update the information. The configuration file 112 may comprise backup service information, on the basis of which the software application 110 may provide or address the automatic notification to the user's backup service.

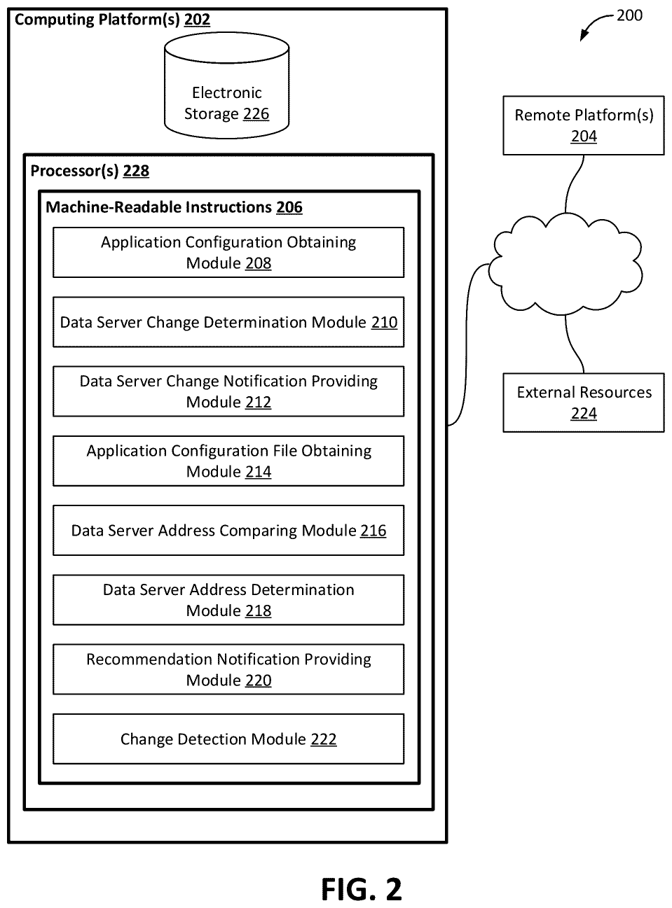

FIG. 2 illustrates a system 200 configured for data server change management with respect to a software application, in accordance with one or more embodiments. In some embodiments, system 200 may include one or more computing platforms 202. Computing platform(s) 202 may be configured to communicate with one or more remote platforms 204 according to a client/server architecture, a peer-to-peer architecture, and/or other architectures. Remote platform(s) 204 may be configured to communicate with other remote platforms via computing platform(s) 202 and/or according to a client/server architecture, a peer-to-peer architecture, and/or other architectures. Users may access system 200 via remote platform(s) 204.

Computing platform(s) 202 may be configured by machine-readable instructions 206. Machine-readable instructions 206 may include one or more instruction modules. The instruction modules may include computer program modules. The instruction modules may include one or more of application configuration obtaining module 208, data server change determination module 210, data server change notification providing module 212, application configuration file obtaining module 214, data server address comparing module 216, data server address determination module 218, recommendation notification providing module 220, change detection module 222, and/or other instruction modules.

Application configuration obtaining module 208 may be configured to obtain, on application start-up, an application configuration file including data server information associated with a data server on which an application database is stored. The application database may be associated with a current client instance of the software application. The data server information may comprise a data server address, for example a uniform resource identifier (URI), such as a uniform resource locator (URL). A URI identifies a resource using a name, location or both, whereas a URL identifies the web address or location of a unique resource.

Data server change determination module 210 may be configured to determine that a data server change has occurred based on a comparison of the data server information in the application configuration file with prior data server information associated with a prior client instance of the software application. The prior client instance of the software application may be associated with an instance immediately preceding the current client instance of the software application.

Data server change notification providing module 212 may be configured to provide a data server change notification to a user associated with the software application based on determining that the data server change has occurred, to avoid application database backup from an out-of-date data server. The user may be, for example an information technology (IT) administrator, or a user of the software application who has been granted administrator rights.

Data server change notification providing module 212 may be configured to provide the data server change notification to the user based on determining that the data server address has changed. Data server change notification providing module 212 may be configured to provide the data server change notification in association with the software application and independent of a backup service. Data server change notification providing module 212 may be configured to provide the data server change notification to an administrator of the software application.

Application configuration file obtaining module 214 may be configured to obtain the application configuration file, for example including a data server address specifying a data server on which an application database is stored. The data server address may include a data server link address. The data server address may include a URI, such as a URL.

Data server address comparing module 216 may be configured to compare the data server address from the configuration file with a prior data server address associated with the prior client instance of the software application.

Data server address determination module 218 may be configured to determine that the data server address has changed in response to detecting a difference between the data server address in the application configuration file and the prior data server address.

Recommendation notification providing module 220 may be configured to provide a reset recommendation notification to the user to reset a data server link with respect to a backup service. Recommendation notification providing module 220 may be configured to provide the reset recommendation notification in association with the software application and independent of the backup service.

Change detection module 222 may be configured to detect, by the software application, a change in a location of the data server on which the application database is stored. In contrast to approaches that may detect a change in a backup server location, the change detection module 222 may be configured to detect a change in the location of the data server storing a current version of the application database. The change detection module 222 may enable notification with respect to the change so that a backup system backs up the proper application database, regardless of the location of or details associated with the backup server.

In some implementations, the software application may include practice management software. In some implementations, the software application may include clinical practice management software. In some implementations, the software application may include dental practice management software.

In some embodiments, computing platform(s) 202, remote platform(s) 204, and/or external resources 224 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 202, remote platform(s) 204, and/or external resources 224 may be operatively linked via some other communication media.

A given remote platform 204 may include one or more processors configured to execute computer program modules. The computer program modules may be configured to enable an expert or user associated with the given remote platform 204 to interface with system 200 and/or external resources 224, and/or provide other functionality attributed herein to remote platform(s) 204. By way of non-limiting example, a given remote platform 204 and/or a given computing platform 202 may include one or more of a server, a desktop computer, a laptop computer, a handheld computer, a tablet computing platform, a NetBook, a Smartphone, a gaming console, and/or other computing platforms.

External resources 224 may include sources of information outside of system 200, external entities participating with system 200, and/or other resources. In some embodiments, some or all of the functionality attributed herein to external resources 224 may be provided by resources included in system 200.

Computing platform(s) 202 may include electronic storage 226, one or more processors 228, and/or other components. Computing platform(s) 202 may include communication lines, or ports to enable the exchange of information with a network and/or other computing platforms. Illustration of computing platform(s) 202 in FIG. 2 is not intended to be limiting. Computing platform(s) 202 may include a plurality of hardware, software, and/or firmware components operating together to provide the functionality attributed herein to computing platform(s) 202. For example, computing platform(s) 202 may be implemented by a cloud of computing platforms operating together as computing platform(s) 202.

Electronic storage 226 may comprise non-transitory storage media that electronically stores information. The electronic storage media of electronic storage 226 may include one or both of system storage that is provided integrally (i.e., substantially non-removable) with computing platform(s) 202 and/or removable storage that is removably connectable to computing platform(s) 202 via, for example, a port (e.g., a USB port, a firewire port, etc.) or a drive (e.g., a disk drive, etc.). Electronic storage 226 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 226 may include one or more virtual storage resources (e.g., cloud storage, a virtual private network, and/or other virtual storage resources). Electronic storage 226 may store software algorithms, information determined by processor(s) 228, information received from computing platform(s) 202, information received from remote platform(s) 204, and/or other information that enables computing platform(s) 202 to function as described herein.

Processor(s) 228 may be configured to provide information processing capabilities in computing platform(s) 202. As such, processor(s) 228 may include one or more of a digital processor, an analog processor, a digital circuit designed to process information, an analog circuit designed to process information, a state machine, and/or other mechanisms for electronically processing information. Although processor(s) 228 is shown in FIG. 2 as a single entity, this is for illustrative purposes only. In some embodiments, processor(s) 228 may include a plurality of processing units. These processing units may be physically located within the same device, or processor(s) 228 may represent processing functionality of a plurality of devices operating in coordination. Processor(s) 228 may be configured to execute modules 208, 210, 212, 214, 216, 218, 220, and/or 222, and/or other modules. Processor(s) 228 may be configured to execute modules 208, 210, 212, 214, 216, 218, 220, and/or 222, and/or other modules by software; hardware; firmware; some combination of software, hardware, and/or firmware; and/or other mechanisms for configuring processing capabilities on processor(s) 228.

As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 208, 210, 212, 214, 216, 218, 220, and/or 222 are illustrated in FIG. 2 as being implemented within a single processing unit, in embodiments in which processor(s) 228 includes multiple processing units, one or more of modules 208, 210, 212, 214, 216, 218, 220, and/or 222 may be implemented remotely from the other modules. The description of the functionality provided by the different modules 208, 210, 212, 214, 216, 218, 220, and/or 222 described below is for illustrative purposes, and is not intended to be limiting, as any of modules 208, 210, 212, 214, 216, 218, 220, and/or 222 may provide more or less functionality than is described. For example, one or more of modules 208, 210, 212, 214, 216, 218, 220, and/or 222 may be eliminated, and some or all of its functionality may be provided by other ones of modules 208, 210, 212, 214, 216, 218, 220, and/or 222. As another example, processor(s) 228 may be configured to execute one or more additional modules that may perform some or all of the functionality attributed below to one of modules 208, 210, 212, 214, 216, 218, 220, and/or 222.

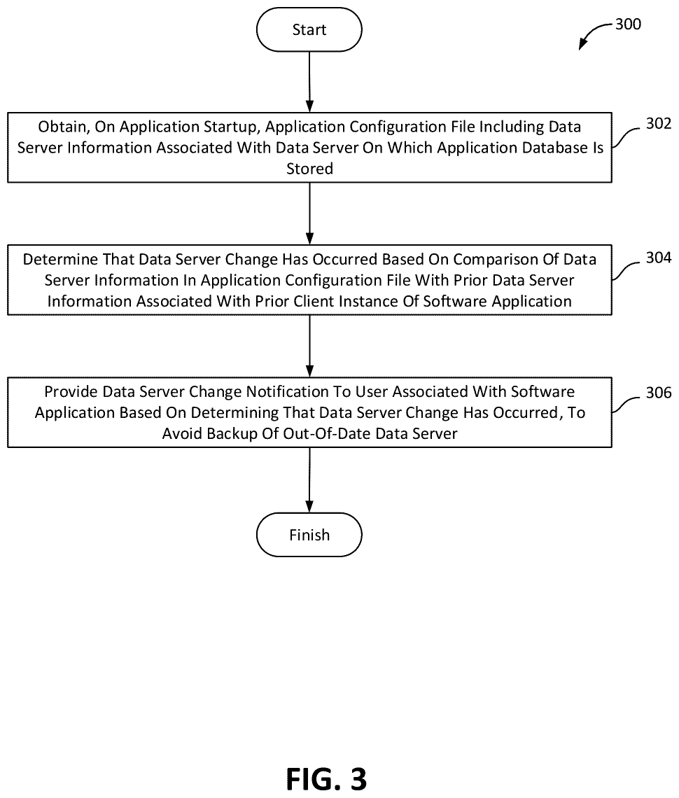

FIG. 3 illustrates a method 300 for data server change management with respect to a software application, in accordance with one or more embodiments. The operations of method 300 presented below are intended to be illustrative. In some embodiments, method 300 may be accomplished with one or more additional operations not described, and/or without one or more of the operations discussed. Additionally, the order in which the operations of method 300 are illustrated in FIG. 3 and described below is not intended to be limiting.

In some embodiments, method 300 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 300 in response to instructions stored electronically on an electronic storage medium. The one or more processing devices may include one or more devices configured through hardware, firmware, and/or software to be specifically designed for execution of one or more of the operations of method 300.

An operation 302 may include obtaining, on application start-up, an application configuration file including data server information associated with a data server on which an application database is stored. The application database may be associated with a current client instance of the software application. Operation 302 may be performed by one or more hardware processors configured by machine-readable instructions including a module that is the same as or similar to application configuration obtaining module 208, in accordance with one or more embodiments.

An operation 304 may include determining that a data server change has occurred based on a comparison of the data server information in the application configuration file with prior data server information associated with a prior client instance of the software application. Operation 304 may be performed by one or more hardware processors configured by machine-readable instructions including a module that is the same as or similar to data server change determination module 210, in accordance with one or more embodiments.

An operation 306 may include providing a data server change notification to a user associated with the software application based on determining that the data server change has occurred, to avoid application database backup from an out-of-date data server. Operation 306 may be performed by one or more hardware processors configured by machine-readable instructions including a module that is the same as or similar to data server change notification providing module 212, in accordance with one or more embodiments.

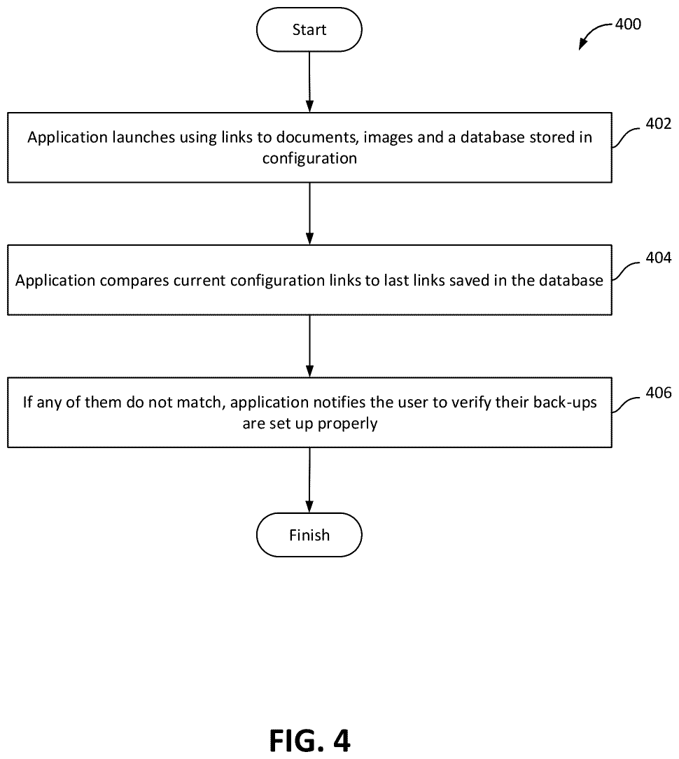

FIG. 4 illustrates another method for data server change management with respect to a software application, in accordance with one or more embodiments. If an application database or database server is replaced, the configuration of the application will be different than it was since the last program launch. Therefore, it is highly likely a new server is in place, and the back-ups should be verified. The operations of method 400 presented below are intended to be illustrative. In some embodiments, method 400 may be accomplished with one or more additional operations not described, and/or without one or more of the operations discussed. Additionally, the order in which the operations of method 400 are illustrated in FIG. 4 and described below is not intended to be limiting.

In some embodiments, method 400 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 400 in response to instructions stored electronically on an electronic storage medium. The one or more processing devices may include one or more devices configured through hardware, firmware, and/or software to be specifically designed for execution of one or more of the operations of method 400. Method 400 may begin when a user triggers application start, for example by launching a client instance of the software application.

An operation 402 may include launching the application, for example using a configuration file. The configuration file may comprise links to documents, images and a database, for example an application database. The application database may be associated with a current client instance of the software application. Operation 402 may be performed by one or more hardware processors configured by machine-readable instructions including an application launching module, in accordance with one or more embodiments.

An operation 404 may include comparing, via the software application, current configuration links to prior links saved in a configuration database. The configuration database may be stored in a memory at the same device as the device running the software application, or may be stored in a memory in communication with the device running the software application. Operation 404 may be performed by one or more hardware processors configured by machine-readable instructions including a configuration comparison module, in accordance with one or more embodiments.

An operation 406 may include notifying the user to verify that backups are set up properly, if any of the current configuration information or links do not match the prior configuration information or links. Operation 406 may be performed by one or more hardware processors configured by machine-readable instructions including a user notification module, in accordance with one or more embodiments.

Embodiments of the present disclosure provide a solution for data server change management. With the ongoing threat of ransomware and other malware, phishing and social engineering attacks, and physical threats such as fire, flood and theft, a sure-fire backup solution is more critical than ever. Embodiments of the present disclosure may enable automatic and regular back up of client application data on cloud servers and help the client recover with minimal downtime in the event of a problem. Embodiments of the present disclosure may provide a remote backup and recovery service, with respect to an application database associated with a client instance of a software application.

If a client replaces a server, embodiments of the present disclosure are configured to identify that the server has changed so the backup configuration data is changed accordingly. Third-party backup solutions may overlook this change and back up the wrong data or no data at all. Embodiments of the present disclosure may provide peace of mind, and offer reliable, secure application database backups and fast recovery with minimal downtime.

In the preceding description, for purposes of explanation, numerous details are set forth in order to provide a thorough understanding of the embodiments. However, it will be apparent to one skilled in the art that these specific details are not required. In other instances, well-known electrical structures and circuits are shown in block diagram form in order not to obscure the understanding. For example, specific details are not provided as to whether the embodiments described herein are implemented as a software routine, hardware circuit, firmware, or a combination thereof.

Embodiments of the disclosure can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a compact disk read only memory (CD-ROM), digital versatile disk (DVD), Blu-ray Disc Read Only Memory (BD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

The above-described embodiments are intended to be examples only. Alterations, modifications and variations can be effected to the particular embodiments by those of skill in the art without departing from the scope, which is defined solely by the claims appended hereto.

Embodiments of the disclosure can be described with reference to the following clauses, with specific features laid out in the example clauses.

One aspect of the present disclosure relates to a system configured for data server change management with respect to a software application. The system may include one or more hardware processors configured by machine-readable instructions. The processor(s) may be configured to obtain, on application start-up, an application configuration file including data server information associated with a data server on which an application database is stored. The application database may be associated with a current client instance of the software application. The processor(s) may be configured to determine that a data server change has occurred based on a comparison of the data server information in the application configuration file with prior data server information associated with a prior client instance of the software application. The processor(s) may be configured to provide a data server change notification to a user associated with the software application based on determining that the data server change has occurred, to avoid application database backup from an out-of-date data server.

In some implementations of the system, the processor(s) may be configured to obtain the application configuration file including a data server address specifying a data server on which an application database is stored. In some implementations of the system, the processor(s) may be configured to compare the data server address from the configuration file with a prior data server address associated with the prior client instance of the software application. In some implementations of the system, the processor(s) may be configured to determine that the data server address has changed in response to detecting a difference between the data server address in the application configuration file and the prior data server address. In some implementations of the system, the processor(s) may be configured to provide the data server change notification to the user based on determining that the data server address has changed.

In some implementations of the system, the processor(s) may be configured to provide the data server change notification in association with the software application and independent of a backup service.

In some implementations of the system, the processor(s) may be configured to provide the data server change notification to an administrator of the software application.

In some implementations of the system, the processor(s) may be configured to provide a reset recommendation notification to the user to reset a data server link with respect to a backup service.

In some implementations of the system, the processor(s) may be configured to provide the reset recommendation notification in association with the software application and independent of the backup service.

In some implementations of the system, the prior client instance of the software application may be associated with an instance immediately preceding the current client instance of the software application.

In some implementations of the system, the processor(s) may be configured to detect, by the software application, a change in a location of the data server on which the application database is stored.

In some implementations of the system, the data server address may include a data server link address.

In some implementations of the system, the data server address may include a uniform resource identifier (URI), such as a uniform resource locator (URL).

In some implementations of the system, the software application may include practice management software.

In some implementations of the system, the software application may include clinical practice management software.

In some implementations of the system, the software application may include dental practice management software.

Another aspect of the present disclosure relates to a method for data server change management with respect to a software application. The method may include obtaining, on application start-up, an application configuration file including data server information associated with a data server on which an application database is stored. The application database may be associated with a current client instance of the software application. The method may include determining that a data server change has occurred based on a comparison of the data server information in the application configuration file with prior data server information associated with a prior client instance of the software application. The method may include providing a data server change notification to a user associated with the software application based on determining that the data server change has occurred, to avoid application database backup from an out-of-date data server.

In some implementations of the method, it may include obtaining the application configuration file including a data server address specifying a data server on which an application database is stored. In some implementations of the method, it may include comparing the data server address from the configuration file with a prior data server address associated with the prior client instance of the software application. In some implementations of the method, it may include determining that the data server address has changed in response to detecting a difference between the data server address in the application configuration file and the prior data server address. In some implementations of the method, it may include providing the data server change notification to the user based on determining that the data server address has changed.

In some implementations of the method, it may include providing the data server change notification in association with the software application and independent of a backup service.

In some implementations of the method, it may include providing the data server change notification to an administrator of the software application.

In some implementations of the method, it may include providing a reset recommendation notification to the user to reset a data server link with respect to a backup service.

In some implementations of the method, it may include providing the reset recommendation notification in association with the software application and independent of the backup service.

In some implementations of the method, the prior client instance of the software application may be associated with an instance immediately preceding the current client instance of the software application.

In some implementations of the method, it may include detecting, by the software application, a change in a location of the data server on which the application database is stored.

In some implementations of the method, the data server address may include a data server link address.

In some implementations of the method, the data server address may include a uniform resource identifier (URI), such as a uniform resource locator (URL).

In some implementations of the method, the software application may include practice management software.

In some implementations of the method, the software application may include clinical practice management software.

In some implementations of the method, the software application may include dental practice management software.

Yet another aspect of the present disclosure relates to a non-transient computer-readable storage medium having instructions embodied thereon, the instructions being executable by one or more processors to perform a method for data server change management with respect to a software application. The method may include obtaining, on application start-up, an application configuration file including data server information associated with a data server on which an application database is stored. The application database may be associated with a current client instance of the software application. The method may include determining that a data server change has occurred based on a comparison of the data server information in the application configuration file with prior data server information associated with a prior client instance of the software application. The method may include providing a data server change notification to a user associated with the software application based on determining that the data server change has occurred, to avoid application database backup from an out-of-date data server.

In some implementations of the computer-readable storage medium, the method may include obtaining the application configuration file including a data server address specifying a data server on which an application database is stored. In some implementations of the computer-readable storage medium, the method may include comparing the data server address from the configuration file with a prior data server address associated with the prior client instance of the software application. In some implementations of the computer-readable storage medium, the method may include determining that the data server address has changed in response to detecting a difference between the data server address in the application configuration file and the prior data server address. In some implementations of the computer-readable storage medium, the method may include providing the data server change notification to the user based on determining that the data server address has changed.

In some implementations of the computer-readable storage medium, the method may include providing the data server change notification in association with the software application and independent of a backup service.

In some implementations of the computer-readable storage medium, the method may include providing the data server change notification to an administrator of the software application.

In some implementations of the computer-readable storage medium, the method may include providing a reset recommendation notification to the user to reset a data server link with respect to a backup service.

In some implementations of the computer-readable storage medium, the method may include providing the reset recommendation notification in association with the software application and independent of the backup service.

In some implementations of the computer-readable storage medium, the prior client instance of the software application may be associated with an instance immediately preceding the current client instance of the software application.

In some implementations of the computer-readable storage medium, the method may include detecting, by the software application, a change in a location of the data server on which the application database is stored.

In some implementations of the computer-readable storage medium, the data server address may include a data server link address.

In some implementations of the computer-readable storage medium, the data server address may include a uniform resource identifier (URI), such as a uniform resource locator (URL).

In some implementations of the computer-readable storage medium, the software application may include practice management software.

In some implementations of the computer-readable storage medium, the software application may include clinical practice management software.

In some implementations of the computer-readable storage medium, the software application may include dental practice management software.

Still another aspect of the present disclosure relates to a system configured for data server change management with respect to a software application. The system may include means for obtaining, on application start-up, an application configuration file including data server information associated with a data server on which an application database is stored. The application database may be associated with a current client instance of the software application. The system may include means for determining that a data server change has occurred based on a comparison of the data server information in the application configuration file with prior data server information associated with a prior client instance of the software application. The system may include means for providing a data server change notification to a user associated with the software application based on determining that the data server change has occurred, to avoid application database backup from an out-of-date data server.

In some implementations of the system, the system may include means for obtaining the application configuration file including a data server address specifying a data server on which an application database is stored. In some implementations of the system, the system may include means for comparing the data server address from the configuration file with a prior data server address associated with the prior client instance of the software application. In some implementations of the system, the system may include means for determining that the data server address has changed in response to detecting a difference between the data server address in the application configuration file and the prior data server address. In some implementations of the system, the system may include means for providing the data server change notification to the user based on determining that the data server address has changed.

In some implementations of the system, the system may include means for providing the data server change notification in association with the software application and independent of a backup service.

In some implementations of the system, the system may include means for providing the data server change notification to an administrator of the software application.

In some implementations of the system, the system may include means for providing a reset recommendation notification to the user to reset a data server link with respect to a backup service.

In some implementations of the system, the system may include means for providing the reset recommendation notification in association with the software application and independent of the backup service.

In some implementations of the system, the prior client instance of the software application may be associated with an instance immediately preceding the current client instance of the software application.

In some implementations of the system, the system may include means for detecting, by the software application, a change in a location of the data server on which the application database is stored.

In some implementations of the system, the data server address may include a data server link address.

In some implementations of the system, the data server address may include a uniform resource identifier (URI), such as a uniform resource locator (URL).

In some implementations of the system, the software application may include practice management software.

In some implementations of the system, the software application may include clinical practice management software.

In some implementations of the system, the software application may include dental practice management software.

Even another aspect of the present disclosure relates to a computing platform configured for data server change management with respect to a software application. The computing platform may include a non-transient computer-readable storage medium having executable instructions embodied thereon. The computing platform may include one or more hardware processors configured to execute the instructions. The processor(s) may execute the instructions to obtain, on application start-up, an application configuration file including data server information associated with a data server on which an application database is stored. The application database may be associated with a current client instance of the software application. The processor(s) may execute the instructions to determine that a data server change has occurred based on a comparison of the data server information in the application configuration file with prior data server information associated with a prior client instance of the software application. The processor(s) may execute the instructions to provide a data server change notification to a user associated with the software application based on determining that the data server change has occurred, to avoid application database backup from an out-of-date data server.

In some implementations of the computing platform, the processor(s) may execute the instructions to obtain the application configuration file including a data server address specifying a data server on which an application database is stored. In some implementations of the computing platform, the processor(s) may execute the instructions to compare the data server address from the configuration file with a prior data server address associated with the prior client instance of the software application. In some implementations of the computing platform, the processor(s) may execute the instructions to determine that the data server address has changed in response to detecting a difference between the data server address in the application configuration file and the prior data server address. In some implementations of the computing platform, the processor(s) may execute the instructions to provide the data server change notification to the user based on determining that the data server address has changed.

In some implementations of the computing platform, the processor(s) may execute the instructions to provide the data server change notification in association with the software application and independent of a backup service.

In some implementations of the computing platform, the processor(s) may execute the instructions to provide the data server change notification to an administrator of the software application.

In some implementations of the computing platform, the processor(s) may execute the instructions to provide a reset recommendation notification to the user to reset a data server link with respect to a backup service.

In some implementations of the computing platform, the processor(s) may execute the instructions to provide the reset recommendation notification in association with the software application and independent of the backup service.

In some implementations of the computing platform, the prior client instance of the software application may be associated with an instance immediately preceding the current client instance of the software application.

In some implementations of the computing platform, the processor(s) may execute the instructions to detect, by the software application, a change in a location of the data server on which the application database is stored.

In some implementations of the computing platform, the data server address may include a data server link address.

In some implementations of the computing platform, the data server address may include a uniform resource identifier (URI), such as a uniform resource locator (URL).

In some implementations of the computing platform, the software application may include practice management software.

In some implementations of the computing platform, the software application may include clinical practice management software.

In some implementations of the computing platform, the software application may include dental practice management software.

What is claimed is:

1. A system configured for data server change management with respect to a software application, the system comprising:
a non-transient computer-readable storage medium having executable instructions embodied thereon; and
one or more hardware processors configured to execute the instructions to:
obtain, on application start-up, an application configuration file including data server information associated with a data server on which an application database is stored, the application database being associated with a current client instance of the software application;
determine that a data server change has occurred based on a comparison of the data server information in the application configuration file with prior data server information associated with a prior client instance of the software application; and
provide a data server change notification to a user associated with the software application based on determining that the data server change has occurred, to avoid application database backup from an out-of-date data server.

2. The system of claim 1, wherein the one or more hardware processors are further configured by the instructions to:
obtain the application configuration file including a data server address specifying a data server on which an application database is stored;
compare the data server address from the configuration file with a prior data server address associated with the prior client instance of the software application;
determine that the data server address has changed in response to detecting a difference between the data server address in the application configuration file and the prior data server address;
provide the data server change notification to the user based on determining that the data server address has changed.

3. The system of claim 1, wherein the one or more hardware processors are further configured by the instructions to:
provide the data server change notification in association with the software application and independent of a backup service.

4. The system of claim 1, wherein the one or more hardware processors are further configured by the instructions to:
provide the data server change notification to an administrator of the software application.

5. The system of claim 1, wherein the one or more hardware processors are further configured by the instructions to:
provide a reset recommendation notification to the user to reset a data server link with respect to a backup service.

6. The system of claim 5, wherein the one or more hardware processors are further configured by the instructions to:
provide the reset recommendation notification in association with the software application and independent of the backup service.

7. The system of claim 1, wherein the prior client instance of the software application is associated with an instance immediately preceding the current client instance of the software application.

8. The system of claim 1, wherein the one or more hardware processors are further configured by the instructions to:
detect, by the software application, a change in a location of the data server on which the application database is stored.

9. The system of claim 1, wherein the data server address comprises a uniform resource identifier (URI).

10. A processor-implemented method of data server change management with respect to a software application, comprising:
obtaining, on application start-up, an application configuration file including data server information associated with a data server on which an application database is stored, the application database being associated with a current client instance of the software application;
determining that a data server change has occurred based on a comparison of the data server information in the application configuration file with prior data server information associated with a prior client instance of the software application; and
providing a data server change notification to a user associated with the software application based on determining that the data server change has occurred, to avoid application database backup from an out-of-date data server.

11. The method of claim 10, further comprising:
obtaining the application configuration file including a data server address specifying a data server on which an application database is stored;
comparing the data server address from the configuration file with a prior data server address associated with the prior client instance of the software application; and
determining that the data server address has changed in response to detecting a difference between the data server address in the application configuration file and the prior data server address; and
providing the data server change notification to the user based on determining that the data server address has changed.

12. The method of claim 10, further comprising:
providing the data server change notification in association with the software application and independent of a backup service.

13. The method of claim 10, further comprising:
providing the data server change notification to an administrator of the software application.

14. The method of claim 10, further comprising:
providing a reset recommendation notification to the user to reset a data server link with respect to a backup service.

15. The method of claim 14, further comprising:
providing the reset recommendation notification in association with the software application and independent of the backup service.

16. The method of claim 10, wherein the prior client instance of the software application is associated with an instance immediately preceding the current client instance of the software application.

17. The method of claim 10, further comprising:
detecting, by the software application, a change in a location of the data server on which the application database is stored.

18. The method of claim 10, wherein the data server address comprises a uniform resource identifier (URI).

19. A non-transient computer-readable storage medium having instructions embodied thereon, the instructions being executable by one or more processors to perform a method for data server change management with respect to a software application, the method comprising:
obtaining, on application start-up, an application configuration file including data server information associated with a data server on which an application database is stored, the application database being associated with a current client instance of the software application;
determining that a data server change has occurred based on a comparison of the data server information in the application configuration file with prior data server information associated with a prior client instance of the software application; and
providing a data server change notification to a user associated with the software application based on determining that the data server change has occurred, to avoid application database backup from an out-of-date data server.

20. The computer-readable storage medium of claim 19, wherein the method further comprises:
obtaining the application configuration file including a data server address specifying a data server on which an application database is stored;
comparing the data server address from the configuration file with a prior data server address associated with the prior client instance of the software application; and
determining that the data server address has changed in response to detecting a difference between the data server address in the application configuration file and the prior data server address; and
providing the data server change notification to the user based on determining that the data server address has changed.
